(19) United States
(12) Patent Application Publication
(10) Pub. No.: US 2016/0280590 A1
(43) Pub. Date: Sep. 29, 2016

(54) GLASS PLATE

(71) Applicant: ASAHI GLASS COMPANY, LIMITED, Chiyoda-ku (JP)

(72) Inventors: Izuru KASHIMA, Tokyo (JP); Yusuke KOBAYASHI, Tokyo (JP)

(73) Assignee: ASAHI GLASS COMPANY, LIMITED, Chiyoda-ku (JP)

(21) Appl. No.: 15/178,627

(22) Filed: Jun. 10, 2016

Related U.S. Application Data
(63) Continuation of application No. 14/189,072, filed on Feb. 25, 2014.
Application No. 14/189,072 is a continuation of application No. PCT/JP2012/070860, filed on Aug. 16, 2012.

(30) Foreign Application Priority Data
Aug. 29, 2011 (JP) 2011-186461

(51) Int. Cl. C03C 19/00

(52) U.S. Cl. CPC C03C 19/00

(57) ABSTRACT

A glass plate includes a main flat surface, an edge surface orthogonal to the main flat surface, and a chamfered surface adjacent to the main flat surface and the edge surface. In a cross-sectional surface of the glass plate that is orthogonal to the edge surface and that is orthogonal to the main flat surface, the chamfered surface has a curvature radius greater than or equal to 50 μm at an intersection point between the chamfered surface and a straight line inclined 45 degrees with respect to the main flat surface and a curvature radius ranging from 20 μm to 500 μm at an intersection point between the chamfered surface and a straight line inclined 15 degrees with respect to the main flat surface.

### CROSS-REFERENCE TO RELATED APPLICATION

This application is a continuation application of U.S. patent application Ser. No. 14/189,072, filed Feb. 25, 2014, which in turn is a U.S. continuation application filed under 35 USC 111(a) claiming benefit under 35 USC 120 and 365(c) of PCT Application JP2012/070860, filed Aug. 16, 2012, which claims the benefit of priority of Japanese Patent Application Ser. No. 2011-186461, filed in Japan on Aug. 29, 2011. The foregoing applications are hereby incorporated herein by reference.

### BACKGROUND OF THE INVENTION

1. Field of the Invention

The present invention relates to a glass plate.

2. Description of the Related Art

In recent years, glass plates have been manufactured for the use of image display apparatuses such as liquid crystal displays and organic EL (Electro Luminescence) displays. For example, a glass substrate may be used as a glass plate on which a function layer such as a thin film transistor (TFT) or a color filter (CF) is formed. Further, a glass plate may be used as a cover glass for improving the aesthetics of a display or increasing protection of the display.

In a case where a glass plate is bent, compression stress is generated in a main flat surface corresponding to a concave surface of the glass plate whereas a tensile stress is generated in a main flat surface corresponding to a convex surface of the glass plate. Such tensile stress tends to concentrate at a border part between the main flat surface corresponding to the convex surface and an edge surface adjacent to the main surface corresponding to the convex surface. Therefore, the glass plate is susceptible to breakage when a defect exists in the border part.

Accordingly, there is proposed a glass plate having a chamfered surface formed at its border part in which a surface roughness of the chamfered surface is less than a surface roughness of its edge surface (see, for example, Patent Document 1).

Patent Document

Patent Document 1: International Publication Pamphlet 10/104039

In Patent Document 1, the quality of a glass plate is evaluated according to flexural strength. However, in some cases, it may be suitable to evaluate the quality of the glass plate according to impact fracture strength. For example, because a glass plate can be hardly bent in a case where the glass plate is mounted on an image display apparatus, impact fracture strength has greater significance than flexural strength.

### SUMMARY OF THE INVENTION

The present invention may provide a glass plate that substantially obviates one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a glass plate particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides a glass plate including a main flat surface, an edge surface orthogonal to the main flat surface, and a chamfered surface adjacent to the main flat surface and the edge surface. In a cross-sectional surface of the glass plate that is orthogonal to the edge surface and that is orthogonal to the main flat surface, the chamfered surface has a curvature radius greater than or equal to 50 μm at an intersection point between the chamfered surface and a straight line inclined 45 degrees with respect to the main flat surface and a curvature radius ranging from 20 μm to 500 μm at an intersection point between the chamfered surface and a straight line inclined 15 degrees with respect to the main flat surface.

### BRIEF DESCRIPTION OF THE DRAWINGS

FIG. 1 is a side view illustrating a glass plate according to an embodiment of the present invention;

FIG. 2 is a schematic view for describing an example of a method for forming a chamfered part;

FIG. 3 is a schematic diagram for describing an example of another method for forming a chamfered part;

FIG. 4 is a schematic diagram for describing an example of forming a curved surface part and a curved part (1);

FIG. 5 is a schematic diagram for describing an example of forming a curved surface part and a curved part (2);

FIG. 6 is a schematic diagram for describing a shape and a dimension of a chamfered surface according to an embodiment of the present invention (1);

FIG. 7 is a schematic diagram for describing a shape and a dimension of a chamfered surface according to an embodiment of the present invention (2);

FIG. 8 is a schematic diagram for describing a shape and a dimension of a chamfered surface according to an embodiment of the present invention (3);

FIG. 9 is a schematic diagram for describing a shape and a dimension of a chamfered surface according to an embodiment of the present invention (4);

FIG. 10 is a side view of a modified example of a glass plate according to an embodiment of the present invention; and

FIG. 11 is a schematic diagram for describing an impact testing machine.

### DESCRIPTION OF THE PREFERRED EMBODIMENTS

In the following, embodiments of the present invention will be described with reference to the accompanying drawings. Throughout the drawings of the embodiments, like components are denoted by like numerals as those of the below-described embodiment and will not be further explained.

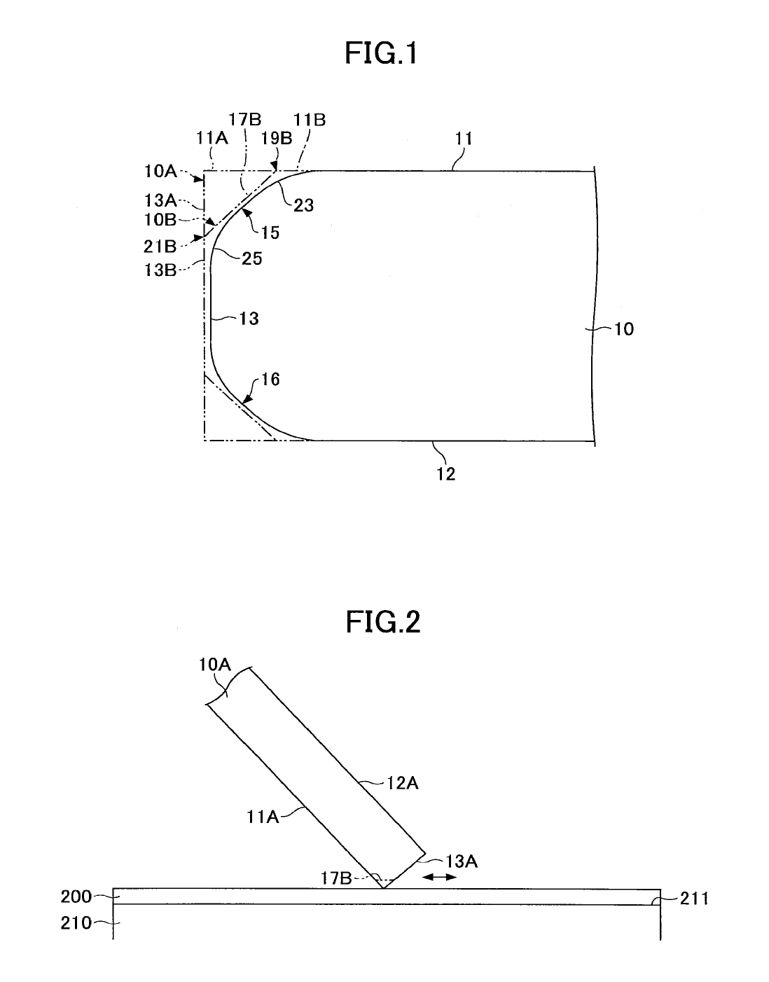

FIG. 1 is a side view illustrating a glass plate according to an embodiment of the present invention. FIG. 1 illustrates, for example, a raw plate of the glass plate with a double-dot-dash line.

The glass plate 10 may be a glass substrate used for an image display apparatus or a cover glass. The image display apparatus may be, for example, a liquid crystal display (LCD), a plasma display panel (PDP), an organic EL (Electro Luminescence) display, or a touch panel.

It is to be noted that, although the glass plate 10 in this embodiment is used for an image display apparatus, the usage of the glass plate 10 is not to be limited in particular. For example, the glass plate 10 may be used for a solar battery or a thin-film secondary battery.

The plate thickness of the glass plate 10 may be set according to the usage of the glass plate 10. For example, in a case where the glass plate 10 is used as a glass substrate for an image display apparatus, the plate thickness of the glass plate 10 is 0.3 mm to 3 mm. Further, in a case where the glass plate 10 is used as a cover glass for an image display apparatus, the plate thickness of the glass plate 10 is, for example, 0.5 mm to 3 mm.

The glass plate 10 may be formed by using a float method, a fusion down-draw method, a redraw method, or a press method. However, the method for forming the glass plate 10 is not limited to the aforementioned methods.

The glass plate 10 includes two main flat surfaces 11, 12 that are parallel to each other, an edge surface 13 that is orthogonal to each of the two main flat surfaces 11, 12, and chamfered surfaces 15, 16 that are formed from the edge surface 113 and corresponding main flat surfaces 11, 12. The chamfered surface 15 is adjacent to the main flat surface 11 and the edge surface 13. The chamfered surface 16 is adjacent to the main flat surface 12 and the edge surface 13.

The glass plate 10 is symmetrically formed with respect to a center plane of the main flat surfaces 11, 12. The chamfered surfaces 15, 16 have substantially the same shapes and dimensions. Thus, in the following, description of one of the chamfered surfaces (in this case, chamfered surface 16) is omitted. It is to be noted that, although the chamfered surfaces 15, 16 have substantially the same shapes and dimensions, the chamfered surfaces 15, 16 may have shapes and dimensions different from each other. Further, the glass plate 10 may be formed without one of the chamfered surfaces 15, 16.

The main flat surfaces 11, 12 may be formed in a rectangular shape. Here, the term “rectangular shape” includes both a quadrate shape and an oblong shape. Further, corner portions of the rectangular-shaped main flat surfaces 11, 12 may have rounded shapes. It is to be noted that the shape of the main flat surfaces 11, 12 is not limited to the aforementioned shapes. For example, the main flat surfaces 11, 12 may have polygonal shapes such as triangular shapes. Alternatively, the main flat surfaces 11, 12 may have a circular shape or an elliptical shape.

The edge surface 13 is a surface orthogonal to the main flat surfaces 11, 12. The edge surface 13 is positioned more outward of the glass plate 10 than the main flat surfaces 11, 12 from a plan view (i.e. viewed from a plate thickness direction). With the edge surface 13, the glass plate 10 can attain satisfactory impact resistance with respect to impact exerted from a direction orthogonal to the edge surface 13.

The edge surface 13 is a flat surface. However, as long as the edge surface 13 is orthogonal to the main flat surfaces 11, 12, the edge surface 13 may be a curved surface. Further, the edge surface 13 may be a constituted by a combination of a flat surface and a curved surface.

For example, four chamfered surfaces 15 may be provided in correspondence with four sides of the rectangular-shaped main flat surface 11. Alternatively, a single chamfered surface 15 may be provided on one of the sides of the rectangular-shaped main flat surface 11. The number of chamfered surfaces 15 which may be provided is not limited to the aforementioned number of chamfered surfaces provided on the side(s) of the rectangular-shaped main flat surface 11.

As one example of a method for forming the chamfered surface 15, the chamfered surface 15 may be formed by forming a chamfered part 17B by removing a corner part between a main flat surface 11A and an edge surface 13A of a raw plate 10A of the glass plate 10, and processing the chamfered part 17B. First, the chamfered part 17B is described below.

The chamfered part 17B is a flat surface that is diagonal with respect to the main flat surface 11B. It is to be noted that, although the chamfered part 17B of this embodiment is a flat surface, the chamfered part 17B may be a curved surface. The curved surface may be, for example, a circular arc surface, an arc surface including multiple circular arc surfaces having different curvature radii, or an elliptical arc surface.

The chamfered part 17B gradually protrudes outward from the main flat surface 11B to an edge surface 13B from a plan view (i.e. viewed from plate-thickness direction). The edge surface 13B is a surface orthogonal to the main flat surface 11B and is adjacent to the chamfered part 17B.

A border part 19B between the chamfered part 17B and the main flat surface 11B is formed into a tapered shape owing to the nature of the chamfering process. Similarly, a border part 21B between the chamfered part 17B and the edge surface 13B is formed into a tapered shape owing to the nature of the chamfering process.

FIG. 2 is a schematic view for describing an example of a method for forming a chamfered part. FIG. 2 illustrates the raw plate 10A of the glass plate 10 and a sheet 200 used for polishing the raw plate 10A. In FIG. 2, the chamfered part 17B is illustrated with a double-dot dash line.

The chamfered part 17B is formed by polishing the raw plate 10A with the sheet 200 including abrasive grains. The sheet 200 is fixed to a fixing surface 211 of a base 210. The sheet 200 has a shape complying with the shape of the fixing surface 211. The fixing surface 211 may be, for example, a flat surface. The sheet 200 includes abrasive grains provided on a surface that is opposite to a surface facing the fixing surface 211. The abrasive grains of the sheet 200 may be, for example, alumina (Al₂O₃), silicon carbide (SiC), or diamond. In order to prevent damage during the polishing process, the granularity of the abrasive grains may be, for example, greater than or equal to #1000. The particle diameters of the abrasive grains become smaller as the granularity increases.

The raw plate 10A is chamfered by pressing the raw plate 10A against the surface of the sheet 200 including abrasive grains and sliding the raw plate 10A along the surface of the sheet 200 including abrasive grains. Thereby, the chamfered part 17B is formed. A coolant such as water may be used during the polishing process.

It is to be noted that, although the sheet 200 of this embodiment is fixed on the base 210 and has its surface including abrasive grains pressed against the raw plate 10A while the raw plate 10A is slid along the surface including abrasive grains, the raw plate 10A may be pressed against the surface including abrasive grains in a state where tension is applied to the sheet 200.

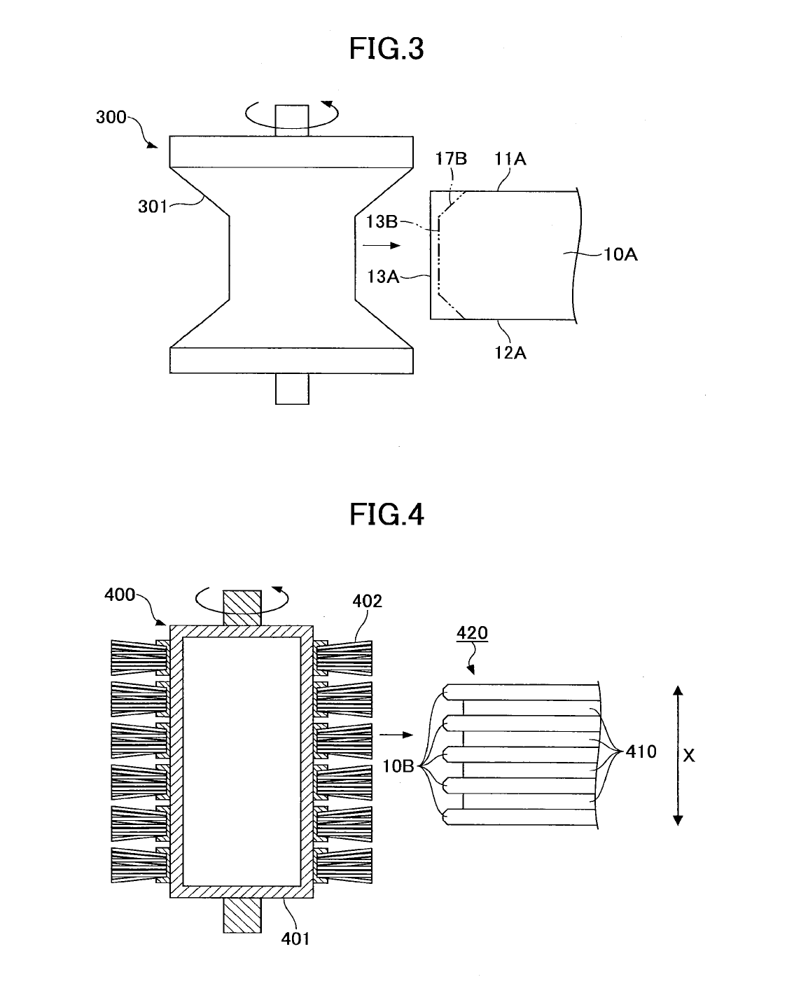

FIG. 3 is a schematic diagram for describing an example of another method for forming a chamfered part. FIG. 3 illustrates the raw plate 10A and a rotary grinding wheel 300 used for grinding the raw plate 10A. In FIG. 3, the chamfered part 17B and the edge surface 13B are illustrated with a double-dot dash line.

The chamfered part 17B and the edge surface 13B are formed by grinding an outer peripheral part of the raw plate 10A with the rotary grinding wheel 300. The rotary grinding wheel 300, which has a disk-like shape, is formed with an annular grinding groove 301 along its outer edge. Abrasive grains are included in a wall surface of the grinding groove 301. The abrasive grains may be, for example, alumina (Al₂O₃), silicon carbide, or diamond. In order to increase grinding efficiency, the granularity of the abrasive grains may be, for example, #300 to #2000 (JIS R6001: Abrasive Micro Grain Size).

The rotary grinding wheel 300 is rotated about a center line of the rotary grinding wheel 300 while being moved relative to the raw plate 10A along the outer edge of the raw plate 10A. Thereby, the outer edge part of the glass plate 10A is grinded by the wall surface of the grinding groove 301. A coolant such as water may be used during the polishing process.

It is to be noted that the method for forming the chamfered part is not limited to the methods described with FIGS. 2 and 3. For example, the methods of FIGS. 2 and 3 may be combined. Alternatively, the method of FIG. 2 may be performed after the method of FIG. 3.

As illustrated in FIG. 1, the chamfered surface 15 is formed by further chamfering the border part 19B (between the chamfered part 17B and the main flat surface 11B) and the border part 21B (between the chamfered part 17B and the edge surface 13B) into curved surfaces, respectively. The curved surface may be, for example, a circular arc surface, or an arc surface including multiple circular arc surfaces having different curvature radii, or an elliptical arc surface. Because the tapered border parts 19B, 21B are processed into curved (rounded) surfaces, the stress generated at the time of impact is caused to scatter as taught in the Hertzian contact stress theory. Accordingly, impact (shock) resistance of the glass plate 10 can be improved. In a case where impact is exerted on the chamfered surface 15, two types of fractures may occur. One type is a fracture A originating from the chamfered surface 15 that has received the impact. The other type is a fracture B originating from the chamfered surface 16 that has not received impact. In this embodiment, impact resistance of the glass plate 10 is improved against the fracture A.

The chamfered surface 15 includes a curved surface part 23 formed by chamfering the border part 19B into a curved surface and a curved part 25 formed by chamfering the border part 21B into a curved surface.

The curved surface part 23 gradually protrudes outward from the main flat surface 11 to the side of the curved part 25 from a plan view (i.e. viewed from plate-thickness direction). Similarly, the curved part 25 gradually protrudes outward from the edge surface 13 to the side of the curved surface part 23 from a plan view.

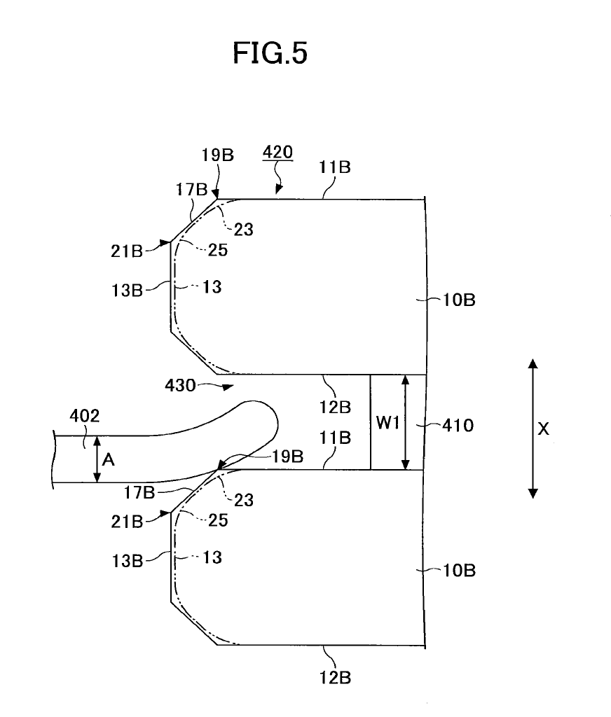

FIGS. 4 and 5 are schematic diagrams for describing an example of forming a curved surface part and a curved part. FIG. 4 illustrates multiple plate glasses 10B formed with the chamfered part 17B and a brush 400 used for polishing the plate glasses 10B. FIG. 5 is an enlarged view illustrating a state where the plate glasses 10B are polished with the brush 400. In FIG. 5, the curved surface part 23, the curved part 25, and the edge surface 13 are illustrated with a double-dot dash line.

The curved surface part 23, the curved part 25, and the edge surface 13 are formed by using the brush 400 to polish the plate glasses 10B including the chamfered parts 17B. In order to improve polishing efficiency, the brush 400 may polish a layered body 420 that includes the plate glasses 10B and spacers 410 alternately provided one on top of the other.

As illustrated in FIG. 4, the plate glasses 10B are formed having substantially the same shape and same dimension. The plate glasses 10B are layered, so that the outer edges of the plate glasses 10B are superposed when viewed from a layer direction of the layered body 420 (direction X in FIGS. 4 and 5). Thereby, the outer edge part of each of the plate glasses 10B can be evenly polished.

Each of the spacers 410 is formed with a material that is softer than the plate glass 10B. For example, the spacer 410 may be formed of a polypropylene resin or a urethane foam resin.

Each of the spacers 410 is formed having substantially the same shape and dimension. Each of the spacers 410 is arranged more inward than the outer edges of the plate glasses 10B in the layer direction of the layered body 420 (i.e. direction X in FIGS. 4 and 5). Thereby, the spacers 410 form groove-like spaces 430 between the plate glasses 10B.

The brush 400 is a brush roll as illustrated in FIG. 4. The brush 400 includes a rotational shaft 401 parallel to the layer direction of the layered body 420 and brush hairs 402 that are retained substantially orthogonal to the rotational shaft 401. The brush 400 is rotated about the rotational shaft 401 while being moved relative to the layered body 420 along the outer edge of the layered body 420. The brush 400 discharges a slurry containing a polishing material to the outer edge of the layered body 420 and polishes (brushes) the outer edge of the layered body 420. The polishing material may be, for example, cerium oxide or zirconia. The particle diameter (D50) of the polishing material may be, for example, less than or equal to 5 μm, and more preferably less than or equal to 2 μm.

The brush 400 is a channel brush that includes a long member (channel) spirally wound around the rotation axis 401. Multiple brush hairs 402 are attached to the channel.

The brush hair 402 is mainly formed of, for example, a resin such as a polyamide resin. The brush hair 402 may also include a polishing material such as alumina (Al₂O₃), silicon carbide, or diamond. The brush hair 402 may have a liner shape and include a tapered leading end part.

In this embodiment, the width W1 of the space 430 is greater than or equal to 1.25 times of the maximum diameter A of the brush hair 402 (W1≧1.25×A). Therefore, as illustrated in FIG. 5, the brush hair 402 can be smoothly inserted into the space 430, so that the border parts 19B between the main flat surfaces 11B and the chamfered parts 17B can be chamfered into curved surfaces by the brush hairs 402. In addition, the border parts 21B between the chamfered parts 17B and the edge surfaces 13B are also chamfered into curved surfaces by the brush hairs 402.

The width W1 of the space 430 is preferably greater than or equal to 1.33×A, and more preferably greater than or equal to 1.5×A. In order to improve efficiency of the polishing (brushing) process, the width W1 of the space 430 may be smaller than the plate thickness of the plate glass 10B.

The curved surface part 23 is formed by polishing the border part 19B between the chamfered part 17B and the main flat surface 11B with the outer peripheral surfaces of the brush hairs 402 of the brush 400. Further, the curved part 25 is formed by polishing the border part 21B between the chamfered part 17B and the edge surface 13B with the outer peripheral surfaces of the brush hairs 11B of the brush 400. When forming the curved surface part 23 and the curved part 25, the entire chamfered part 17B is polished to become a curved (rounded) surface. Further, the edge surface 13B is polished to become the edge surface 13 illustrated in FIG. 1.

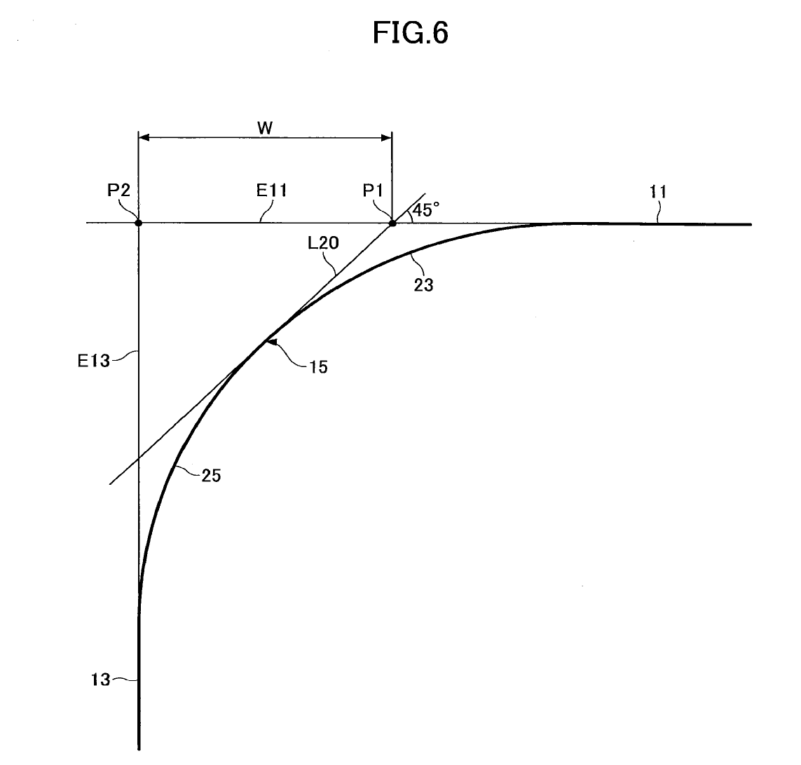

FIGS. 6 to 9 are schematic diagrams for describing a shape and a dimension of a chamfered surface according to an embodiment of the present invention.

As illustrated in FIG. 6, at a cross-sectional surface of the glass plate 10 that is orthogonal to the edge surface 13 and that is orthogonal to the main flat surface 11, a chamfered surface 15 is formed, so that a chamfer width W is, for example, greater than or equal to 20 μm in a direction orthogonal to the edge surface 13.

The chamfer width W is calculated as a distance between an intersection point P1 and an intersection point P2. The intersection point P1 is a point where a straight line L20 and an extension line E11 of the main flat surface 11 intersect. The straight line L20 is inclined 45 degrees with respect to the main flat surface 11 and is tangential to a single point of the chamfered surface 15. The extension line E11 of the main flat surface 11 is a line extending from the main flat surface 11. The intersection point P2 is a point where the extension line E11 of the main flat surface 11 and an extension line E13 of the edge surface 13 intersect. The extension line E13 is a line extending from the edge surface 13. An inclination of a line with respect to the main flat surface 11 is assumed to be 0 degrees in a case where the line is parallel to the main flat surface 11.

In a case where the chamfer width W is greater than or equal to 20 μm, a satisfactory impact resistance can be attained with respect to impact (shock) from a direction orthogonal to the straight line L20, and a 45 degree impact fracture strength (see below-described working examples) becomes high. An upper limit value of the chamfer width W is not limited in particular. However, in a case where the glass plate 10 has a symmetrical shape with respect to its center surface in the plate-thickness direction, the chamfer width W may be less than ½ of the plate-thickness of the glass plate 10. The chamfer width W is preferably greater than or equal to 40 μm.

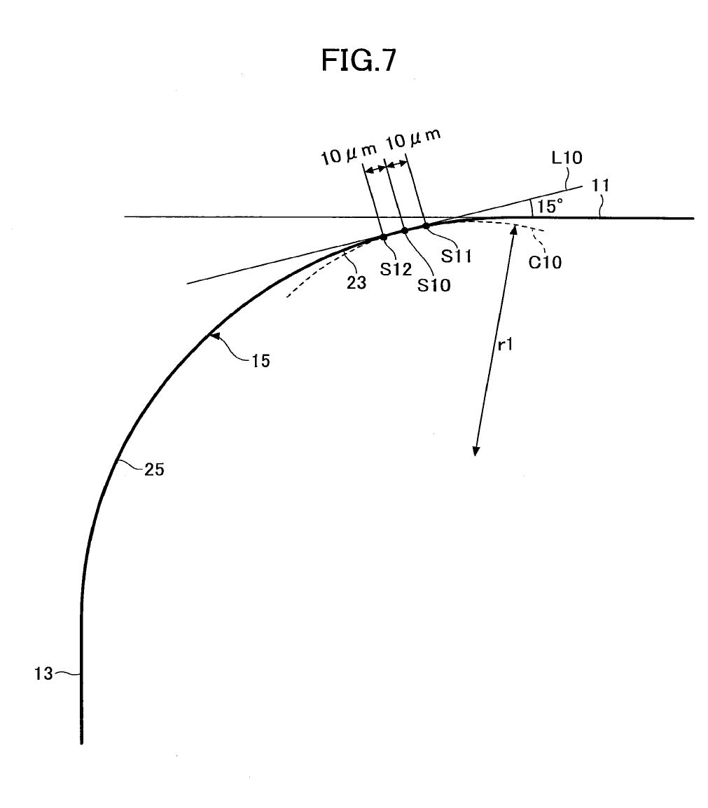

As illustrated in FIG. 7, at a cross-sectional surface of the glass plate 10 that is orthogonal to the edge surface 13 and that is orthogonal to the main flat surface 11, the chamfered surface 15 is formed to have a curvature radius r1 of, for example, 20 μm to 500 μm at its tangent point S10 with respect to a straight line L10. The straight line L10 is inclined 15 degrees with respect to the main flat surface 11.

The curvature radius r1 at the tangent point S10 is calculated as a radius of a perfect circle C10 that passes through 3 points including a point S11, a point S12, and the tangent point S10 that are located on the chamfered surface 15. Each of the points S11, S12 is positioned 10 μm away from the tangent point S10 in a direction parallel to the straight line L10.

In a case where the curvature radius r1 at the tangent point S10 is greater than or equal to 20 μm, the border part 19B between the chamfered part 17B and the main flat surface 11B can be sufficiently chamfered into a curved surface. Further, in a case where the curvature radius r1 at the tangent point S10 is less than or equal to 500 μm, an intersecting area between the curved surface part 23 and the main flat surface 11 can be prevented from becoming acute. Thus, the impact resistance at this area can be prevented from degrading. The curvature radius r1 at the tangent point S10 is preferably 40 μm to 500 μm.

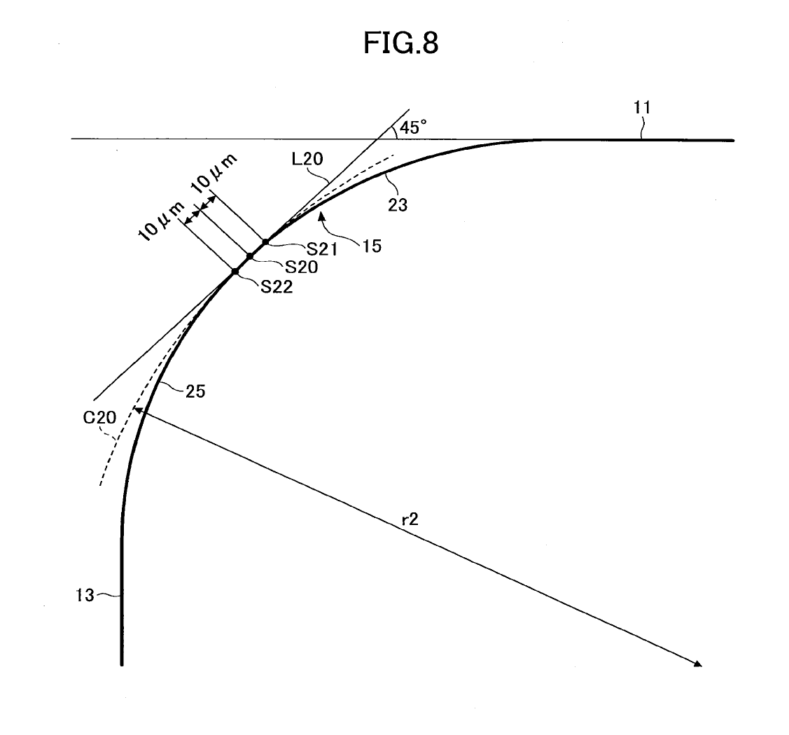

As illustrated in FIG. 8, at a cross-sectional surface of the glass plate 10 that is orthogonal to the edge surface 13 and that is orthogonal to the main flat surface 11, the chamfered surface 15 is formed to have a curvature radius r2 that is larger than the curvature radius r1 at its tangent point S20 with respect to a straight line L20. The straight line L20 is inclined 45 degrees with respect to the main flat surface 11.

The curvature radius r2 at the tangent point S20 is calculated as a radius of a perfect circle C20 that passes through 3 points including a point S21, a point S22, and the tangent point S20 that are located on the chamfered surface 15. Each of the points S21, S22 is positioned 10 μm away from the tangent point S20 in a direction parallel to the straight line L10.

In a case where the curvature radius r2 at the tangent point S20 is greater than the curvature radius r1 at the tangent point S10, a surface for receiving impact (shock) from a direction orthogonal to the straight line L20 becomes wide. Thus, the 45 degree impact fracture strength (see below-described working examples) becomes high. The curvature radius r2 at the tangent point S20 is, for example, greater than or equal to 50 μm, and more preferably greater than or equal to 70 μm.

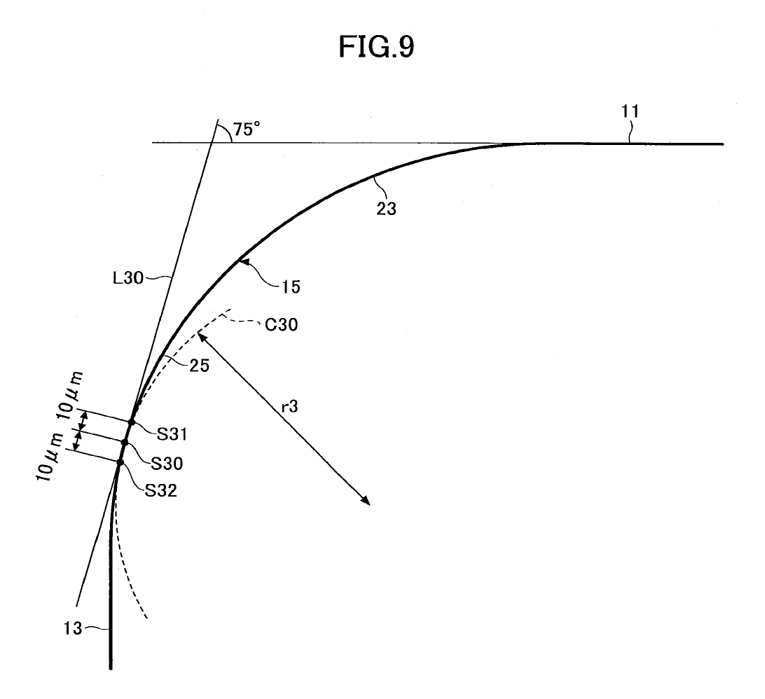

As illustrated in FIG. 9, at a cross-sectional surface of the glass plate 10 that is orthogonal to the edge surface 13 and that is orthogonal to the main flat surface 11, the chamfered surface 15 is formed to have a curvature radius r3 of, for example, 20 μm to 500 μm at its tangent point S30 with respect to a straight line L30. The straight line L30 is inclined 75 degrees with respect to the main flat surface 11.

The curvature radius r3 at the tangent point S30 is calculated as a radius of a perfect circle C30 that passes through 3 points including a point S31, a point S32, and the tangent point S30 that are located on the chamfered surface 15. Each of the points S31, S32 is positioned 10 μm away from the tangent point S30 in a direction parallel to the straight line L30.

In a case where the curvature radius r3 at the tangent point S30 is greater than or equal to 20 μm, the border part 21B between the chamfered part 17B and the edge surface 13B can be sufficiently chamfered into a curved surface. Further, in a case where the curvature radius r3 at the tangent point S30 is less than or equal to 500 μm, an intersecting area between the curved part 25 and the edge surface 13 can be prevented from becoming acute. Thus, the impact resistance at this area can be prevented from degrading. The curvature radius r3 at the tangent point S30 is preferably 40 μm to 500 μm.

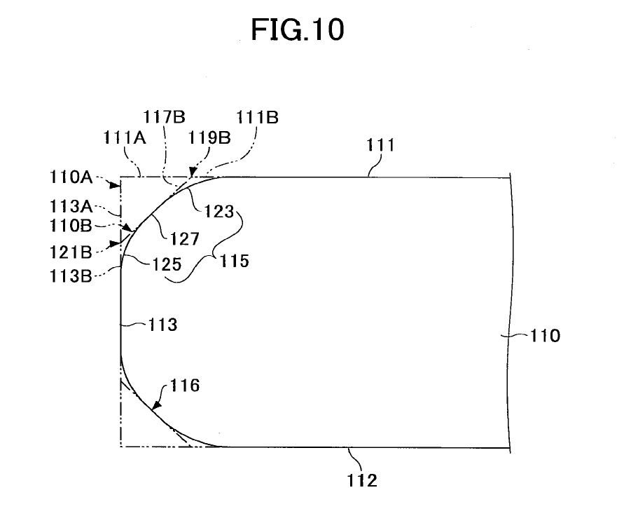

FIG. 10 is a side view of a modified example of a glass plate according to an embodiment of the present invention. Similar to the glass plate 10 illustrated in FIG. 1, a glass plate 110 illustrated in FIG. 10 includes main flat surfaces 111, 112, an edge surface 113 orthogonal to each of the main flat surfaces 111, 112, and chamfered surfaces 115, 116 that are formed between the edge surface 113 and corresponding main flat surfaces 111, 112. The glass plate 110 is symmetrically formed with respect to a center plane of the main flat surfaces 111, 112 in the plate-thickness direction of the glass plate 110. The chamfered surfaces 115, 116 have substantially the same shapes and dimensions. Thus, in the following, description of one of the two main flat surfaces (in this case, chamfered surface 116) is omitted.

It is to be noted that, although the chamfered surfaces 115, 116 have substantially the same shapes and dimensions, the chamfered surfaces 115, 116 may have shapes and dimensions different from each other. Further, the glass plate 110 may be formed without one of the chamfered surfaces 115, 116.

Similar to the chamfered surface 15 illustrated in FIG. 1, the chamfered surface 115 may be formed by forming a chamfered part 117B by removing a corner part between a main flat surface 111A and an edge surface 113A of a raw plate 110A of the glass plate 110, and processing the chamfered part 117B.

The chamfered surface 115 is formed by chamfering a border part 119B between the chamfered part 117B and the main flat surface 111B adjacent to the chamfered part 117B and a border part 121B between the chamfered part 117B and the edge surface 113B adjacent to the chamfered part 117B. The border parts 119B, 121B are chamfered into more curved surfaces compared to the above-described border parts 19B, 21B. Because the tapered border parts 119B, 121B are processed into curved (rounded) surfaces, the stress generated at the time of impact is caused to scatter as taught in the Hertzian contact stress theory. Accordingly, impact (shock) resistance of the glass plate 110 can be improved.

The chamfered surface 115 includes a curved surface part 123 formed by chamfering the border part 119B into a curved surface and a curved part 125 formed by chamfering the border part 121B into a curved surface. The chamfered surface 115 further includes a flat part 127 between the curved surface part 123 and the curved part 125. The flat part 127 is diagonal to the main flat surface 111. Accordingly, the glass plate 110 can attain satisfactory impact resistance with respect to impact exerted from a direction orthogonal to the flat part 127.

For example, the chamfered surface 115 may be formed by forming the chamfered part 117B with the method described with FIG. 2 or FIG. 3 and then polishing only the border parts 119B, 121B with a brush. The flat part 127 is a part of the chamfered part 117B that remains by not being processed (chamfered) during the forming of the curved surface part 123 and the curved part 125. It is, however, to be noted that the flat part 127 may be formed by processing the chamfered part 117B.

### WORKING EXAMPLES

The composition of the glass plates used in the following working examples, in mass percent (mol. %), was 64.2% of Si, 8.0% of Al₂O₃, 10.5% of MgO, 12.5% of Na₂O, 4.0% of K₂O, 0.5% of ZrO₂, 0.1% of CaO, 0.1% of SrO, and 0.1% of BaO. No chemically strengthened layer was included in the glass plates.

### Example 1

In example 1, a sample was manufactured by forming a chamfered part by polishing a rectangular-shaped glass raw plate (plate-thickness: 0.8 mm) with the method described in FIG. 2 and forming a curved surface part and a curved part with the method described in FIG. 4. Then, the impact fracture strength of the sample was tested. The sample did not have a chemically strengthened layer.

A wrapping film sheet (#8000, manufactured by Sumitomo 3M Limited) was used as a sheet for forming the chamfered part. Further, a brush having polyimide brush hairs was used as a brush for forming the curved surface part and the curved part. The diameter of the brush hair was 0.2 mm. Further, cerium oxide having an average particle diameter (D50) of 2 μm was used as a polishing material for polishing with the brush.

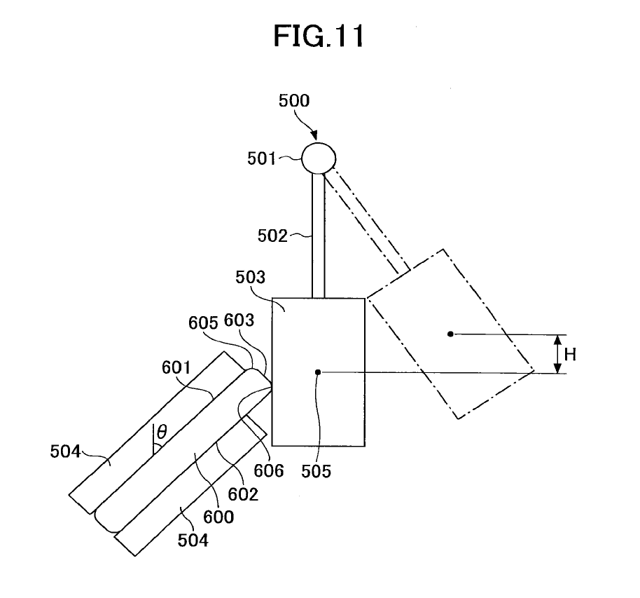

FIG. 11 is a schematic diagram for describing an impact testing machine. FIG. 11 illustrates an impact testing machine 500 and a sample 600. In FIG. 11, a solid line indicates a state in which an impact oscillator 503 is in a neutral position whereas a dash-dot line indicates a state in which the impact oscillator 503 is raised from the neutral state.

The sample 600 includes two main flat surfaces 601, 602 that are parallel to each other, a flat edge surface 603 that is orthogonal to each of the main flat surfaces 601, 602, and chamfered surfaces 605, 606 that are formed between the edge surface 603 and corresponding main flat surfaces 601, 602. The sample 600 is symmetrically formed with respect to a center plane of the main flat surfaces 601, 602. The chamfered surfaces 605, 606 have substantially the same shapes and dimensions. The chamfered surfaces 605, 606 have substantially the same configurations as the configurations illustrated in FIG. 1.

The impact testing machine 500 includes a rotational shaft 501 that is arranged in a horizontal position, a rod 502 that extends in a vertical direction from the rotational shaft 501, and the impact oscillator 503 having a circular-columnar shape and coaxially fixed to the rod 502. The impact oscillator 503 has a mass of 96 g and is formed of a SS (Stainless Steel) material. A part of the impact oscillator 503 that contacts the sample 600 has a curvature radius of 2.5 mm. The impact oscillator 503 can rotate about the rotational shaft 501. Further, the impact oscillator 503 can rotate left and right with respect to the neutral position (position in which the rod 502 is in a vertical state).

The impact testing machine 500 includes a jig 504 that supports the main flat surfaces 601, 602 of the sample 600 in an inclined position with respect to a vertical surface. The main flat surfaces 601, 602 are inclined at a predetermined angle θ such as 45 degrees or 30 degrees with respect to the vertical surface. The jig 504 supports the sample 600, so that a longitudinal direction of the chamfered surface 606 becomes parallel to the rotational shaft 501.

As illustrated with a double-dot dash line in FIG. 11, the impact test was performed by raising the impact oscillator 503 from the neutral position and lowering the impact oscillator 503 by gravity. The impact oscillator 503 rotates about the rotational shaft 501 by gravity and collides with the sample 600 (technically, a lower side of the chamfered surface 606) at the neutral position as illustrated with the solid line in FIG. 11.

The impact energy exerted to the sample 600 when the impact oscillator 503 collides with the sample 600 was calculated according to the mass of the rod 502 (16 g), the mass of the impact oscillator 503 (80 g), and the height H in which a center of gravity 505 of the impact oscillator 503 is raised.

Then, it was determined whether any cracks are formed in the sample 600 by visual observation. In a case where no cracks were formed, the test was repeated by increasing the height H for raising the impact oscillator 503. The impact position of the impact oscillator 503 was changed each time the impact test was performed. A maximum impact energy when a crack(s) is formed is recorded as an impact fracture strength (J).

The shapes and the dimensions (chamfer width W of FIG. 6, curvature radius r1 of FIG. 7, curvature radius r2 of FIG. 8, and curvature radius of FIG. 9) of the chamfered surface 606 with which the impact oscillator 503 collides were measured (evaluated) by cutting the sample 600 after the impact test and observing a cross-sectional surface of the cut sample 600.

Results of the evaluation are shown in the below-described Table 1. In Table 1, “45° impact fracture strength” indicates the impact fracture strength in a case where angle θ of FIG. 11 is 45 degrees. Further, in Table 1, “30 impact fracture strength” indicates the impact fracture strength in a case where angle θ of FIG. 11 is 30 degrees.

### Example 2

In example 2, a sample was manufactured under the same conditions as the conditions of example 1 except that the polishing time for forming a chamfered part of the sample was changed. After forming the sample, impact fracture resistance of the sample was measured. Further, the shape and the dimensions of the chamfered part of the sample were measured. Results of the measurements are shown in the below-described Table 1.

### Example 3

In example 3, a sample was manufactured under the same conditions as the conditions of example 1 except that the method illustrated in FIG. 3 was used instead of the method illustrated in FIG. 2 for forming a chamfered part of the sample. After forming the sample, impact fracture resistance of the sample was measured. Further, the shape and the dimensions of the chamfered part of the sample were measured. Results of the measurements are shown in the below-described Table 1.

### Examples 4-5

In examples 4 and 5, samples were manufactured under the same conditions as the condition of example 1 except that a curved surface part and a curved part of the sample were not formed after forming a chamfered part of the sample. Therefore, the chamfered surfaces of the samples of the examples 4 and 5 are constituted only by chamfered parts. Thus, the chamfered part of each of the examples 4 and 5 is a flat surface that is diagonal to a main surface of the samples of the examples 4 and 5. The polishing time for forming a chamfered part was changed between the examples 4 and 5.

Results of the evaluation of the examples 4 and 5 are shown in the below-described Table 1. Because the chamfered surfaces in examples 4 and 5 are flat surfaces, the curvature radii of the chamfered surfaces in examples 4 and 5 are infinite. Further, in examples 4 and 5, both a curvature radius r1 at an area between the main flat surface and the chamfered surface and a curvature radius r3 at an area between the chamfered surface and the edge surface are assumed to be 0 μm because the area between the main flat surface and the chamfered surface and the area between the chamfered surface and the edge surface having a curvature radius of r1 have bent shapes that do not include the curved surface part or the curved part.

### Example 6

In example 6, the same glass raw plate used in example 1 was used as a sample of example 6. The sample of example 6 includes two main flat surfaces that are parallel to each other, and an edge surface that is orthogonal to each of the main flat surfaces. The sample of example 6 has no chamfered surface.

Results of the evaluation of the example 6 are shown in the below-described Table 1. In example 6, the impact oscillator 503 collided with a corner part between a main flat surface and an edge surface on the lower side of the sample because the sample of example 6 has no chamfered surface. Thus, the impact fracture strength of the sample of example 6 was significantly low.

TABLE 1

| | | | | | 45° IMPACT | 30° IMPACT |
|---|---|---|---|---|---|---|
| | CHAMFER | CURVATURE | CURVATURE | CURVATURE | FRACTURE | FRACTURE |
| | WIDTH W | RADIUS r1 | RADIUS r2 | RADIUS r3 | STRENGTH | STRENGTH |
| | (μm) | (μm) | (μm) | (μm) | (J) | (J) |
| EXAMPLE 1 | 130 | 60 | 60 | 50 | 0.014 | 0.012 |
| EXAMPLE 2 | 160 | 80 | 85 | 60 | 0.018 | 0.018 |
| EXAMPLE 3 | 200 | 140 | 280 | 120 | 0.035 | 0.030 |
| EXAMPLE 4 | 40 | 0 | INFINITE | 0 | 0.004 | 0.002 |
| EXAMPLE 5 | 55 | 0 | INFINITE | 0 | 0.007 | 0.002 |
| EXAMPLE 6 | 0 | — | — | — | 0.001 | 0.001 |

Hence, with the above-described embodiments of the present invention, a glass plate having satisfactory impact fracture strength can be provided.

Although embodiments of a glass plate have been described above, the present invention is not limited to these embodiments, but variations and modifications may be made without departing from the scope of the present invention.

For example, although the glass plate 10 in the above-described embodiments does not include a chemically strengthened layer, the glass plate 10 may include a chemically strengthened layer. In a case where a chemically strengthened layer (compression stress layer) is included in the glass plate 10, the glass plate 10 is formed by immersing glass into a process liquid used for ion-exchange. Thus, ions that have small ion radii and are contained in a surface of the glass (e.g., Li ions, Na ions) are replaced with ions that have large ion radii (e.g., K ions). As a result, the compression stress layer is formed having a predetermined depth from the surface of the glass. A tensile stress layer is formed inside the glass plate 10 for maintaining balance of stress. A chemically strengthened glass plate, in other words, a glass plate having a chemically strengthened layer (compression stress layer) formed in its main flat surface has high strength and high scratch resistance. Therefore, by chemically strengthening the glass plate 10 according to an embodiment of the present invention, the glass plate 10 can become more resistant to fracture and scratches. Accordingly, the glass plate 10 can be suitably used as a cover glass for protecting a display of a smartphone a tablet type PC (Personal Computer), a computer monitor, or a television set.

1. A glass plate comprising:
a main flat surface;
and
a chamfered surface adjacent to the main flat surface;
wherein the chamfered surface has a curvature radius (r2) greater than or equal to 50 μm at a point where the chamfered surface and a straight line inclined 45 degrees with respect to the main flat surface are tangent, and a curvature radius (r1) ranging from 20 μm to 500 μm at a point where the chamfered surface and a straight line inclined 15 degrees with respect to the main flat surface are tangent.

2. (canceled)

3. The glass plate as claimed in claim 1,
wherein the curvature radius (r2) is greater than a curvature radius (r1).

4. (canceled)

5. The glass plate as claimed in claim 1 wherein the main flat surface comprises a chemically strengthened layer.

6. (canceled)

7. A cover glass of a display, comprising the glass plate as claimed in claim 5.

8. The glass plate as claimed in claim 1, wherein the glass plate further comprises an edge surface which is orthogonal to the main flat surface.

9. The glass plate as claimed in claim 8, wherein the chamfered surface has a chamfer width ranging from 20 μm to 500 μm in a direction orthogonal to the edge surface.

10. The glass plate as claimed in claim 1, wherein the curvature radius (r2) ranges from 50 μm to 280 μm.

11. The glass plate as claimed in claim 1, wherein the chamfered surface has a curvature radius (r3) ranging from 20 μm to 500 μm at a point where the chamfered surface and a straight line inclined 75 degrees with respect to the main flat surface are tangent.

12. The glass plate as claimed in claim 11, wherein the curvature radius (r3) ranges from 40 μm to 500 μm.

13. The glass plate as claimed in claim 1, wherein the glass plate comprises a first chamfered surface adjacent to a first main flat surface, and a second chamfered surface adjacent to a second main flat surface opposite to the first main flat surface, and the first chamfered surface and the second chamfered surface have shapes and dimensions different from each other.

14. The glass plate as claimed in claim 1, wherein the glass plate comprises a first chamfered surface adjacent to a first main flat surface, and does not comprise a second chamfered surface adjacent to a second main flat surface opposite to the first main flat surface.

15. The glass plate as claimed in claim 1, wherein the chamfered surface comprises a first curved surface portion adjacent to the main flat surface and a second curved surface adjacent to an outer periphery of the glass plate.

16. The glass plate as claimed in claim 1, wherein a 45° impact fracture strength of the glass plate is from 0.014 to 0.035 J, wherein the 45° impact fracture strength is a maximum energy of an impact oscillator in which no cracks occur in the glass plate by colliding the impact oscillator horizontally to the chamfered surface of the glass plate the main surface of which is inclined at 45° with respect to a vertical direction, provided that the impact oscillator is made of stainless steel and has a weight of 96 g, and a curvature of a surface of the impact oscillator which collides the glass plate is 2.5 mm.

17. The glass plate as claimed in claim 1, wherein a 30° impact fracture strength of the glass plate is from 0.012 to 0.030 J, wherein the 30° impact fracture strength is a maximum energy of an impact oscillator in which no cracks occur in the glass plate by colliding the impact oscillator horizontally to the chamfered surface of the glass plate the main surface of which is inclined at 30° with respect to a vertical direction, provided that the impact oscillator is made of stainless steel and has a weight of 96 g, and a curvature of a surface of the impact oscillator which collides the glass plate is 2.5 mm.
